(19) United States
(12) Patent Application Publication
(10) Pub. No.: US 2008/0213533 A1
(43) Pub. Date: Sep. 4, 2008

(54) PAPER MACHINE CLOTHING

(76) Inventors: Arved Westerkamp, Dettingen/Erms (DE); Hubert Walkenhaus, Kerpen (DE)

Correspondence Address: Todd T. Taylor;Taylor & Aust, P.C., 142 S. Main Street, P.O. Box 560, Avilla, IN, 46710, US

(21) Appl. No.: 12/047,648

(22) Filed: Mar. 13, 2008

Related U.S. Application Data
(63) Continuation of application No. PCT/EP2006/065552, filed on Aug. 22, 2006.

(30) Foreign Application Priority Data
Sep. 23, 2005 (DE) DE102005045 429.1

(51) Int. Cl. B32B 5/12

(52) U.S. Cl. 428/107

(57) ABSTRACT

A paper machine clothing includes a reinforcing matrix, which includes a plurality of linear reinforcing elements oriented in at least three different directions and/or non-linear reinforcing elements.

### CROSS REFERENCE TO RELATED APPLICATIONS

This is a continuation of PCT application No. PCT/EP2006/065552, entitled “PAPER MACHINE CLOTHING”, filed Aug. 22, 2006, which is incorporated herein by reference.

### BACKGROUND OF THE INVENTION

1. Field of the Invention

This invention relates to a paper machine clothing with a reinforcing matrix.

2. Description of the Related Art

The use of reinforcing threads applied to films as a load-carrying basic structure for paper machine clothings, such as in particular press felts, is known.

Already described in the publications EP 1 357 223 A1, EP 1 359 251 A1 and EP 1 359 252 A1 are porous paper machine clothings for dewatering a paper web in a paper machine, which have a thread plaiting of at least one layer of longitudinal threads and at least one layer of transverse threads crossing the longitudinal threads. Again it is possible for these thread plaitings, too, to be used in particular for the reinforcement of press felts.

What is needed in the art is an improved paper machine clothing of the type initially referred to. At the same time it should be possible to use this paper machine clothing as a press belt, preferably as a press felt.

### SUMMARY OF THE INVENTION

The present invention provides a paper machine clothing with a reinforcing matrix, which includes a plurality of linear reinforcing elements oriented in at least three different directions and/or non-linear reinforcing elements.

Hence according to the invention, provision is made for a multidirectional orientation of the reinforcing elements. At the same time the clothing of the invention can be used in particular as a press belt, preferably as a press felt, on the paper machine in question. The reinforcing matrix according to the invention contributes essentially to improving the running characteristics of the press belt because the distribution of forces needing to be absorbed in particular before, in and/or after a respective press nip can be optimized through a selective distribution of the reinforcing elements across the overall width of the press belt or press felt.

Furthermore, by using the arrangement of reinforcing elements according to the invention it is possible to establish an irregular pattern in the reinforcing structure, by way of which it is possible to establish a diffuse mechanical and/or hydraulic distribution of pressure across, for example, the width of the paper machine clothing, thus leading to a reduction of the tendency toward marking.

If it is assumed that the distribution of pressure in the press nip is approximately linear but, owing to the characteristic behavior of the rollers and the wear behavior of the press belt, not homogeneous, then different forces arise in the different zones within the press nip, which is accompanied by an accordingly inhomogeneous drying profile or moisture profile across the width.

The forces which need to be absorbed can now be optimally distributed by way of the arrangement of reinforcing elements within the paper machine clothing or press belt. At the same time the respective distribution scheme for the reinforcing elements can be optimized by way of the finite element method for example.

Apart from an orientation in the machine running direction and an orientation in the transverse direction, all orientations in any oblique direction with respect to the machine running direction are possible in principle. There is also the possibility in particular of a partial reinforcement of the clothing and a non-linear orientation of the reinforcing elements.

The linear reinforcing elements can be oriented in at least three different directions as viewed in the plane or surface of the clothing extending in the machine running direction and in the transverse direction.

Advantageously the linear reinforcing elements are oriented in more than three different directions.

On a practical embodiment of the paper machine clothing according to the invention the reinforcing matrix includes at least one thread plaiting with reinforcing threads or strips as linear reinforcing elements.

It is expedient for at least a part of the linear reinforcing elements to be oriented in the machine running direction, in the transverse direction and/or in a direction extending obliquely with respect to the machine running direction.

On an advantageous embodiment provision is made for linear reinforcing elements which are oriented only partially in at least three different directions as viewed in particular in the transverse direction or for non-linear reinforcing elements.

The reinforcing elements can form pores at least in some regions. In this case, polygonal pore structures are advantageously formed at least in some regions by the reinforcing elements. Such polygonal pore structures can be represented in particular by thread plaitings of different angularity.

Advantageously the reinforcing matrix can also be multilayer.

At the same time, in particular in the case of a multilayer matrix, the reinforcing elements form pores which can be superimposed on each other.

It is also advantageous in particular for the reinforcing matrix, viewed in the transverse direction, to include different reinforcing regions which differ from each other in particular in respect of the orientation and/or distribution of the reinforcing elements. In this case the different reinforcing regions, viewed in the transverse direction, can be distributed symmetrically or also asymmetrically relative to the middle of the clothing.

It is expedient for the linear reinforcing elements, viewed in the transverse direction, to have an asymmetric distribution of orientation relative to the middle of the clothing. In this case the linear reinforcing elements can be distributed in particular over several layers.

Hence, for example, a non-symmetric distribution of reinforcing threads or strips in different angular directions with respect to the running direction is possible, as the result of which the tendency of the carrier, meaning the felt carrier for example, toward marking is reduced accordingly. As already mentioned, this constellation can also be arranged in several layers one above the other.

According to a practical embodiment of the paper machine clothing according to the invention, the reinforcing matrix includes several layers with reinforcing threads or strips of different orientation extending across the overall width or surface of the clothing.

In this case it is expedient for the layers to be joined together, whereby they can either be continuously joined together at least essentially or be only partially joined together.

According to another expedient embodiment, the reinforcing matrix includes several layers with reinforcing threads or strips of different orientation extending across only one or more sub-regions of the width or surface of the clothing.

In this case, too, it is again expedient in particular for layers atop one another to be joined together, whereby they can either be continuously joined together at least essentially or be only partially joined together.

It is also advantageous in particular for the reinforcing matrix to include several layers with reinforcing threads or strips of different orientation extending across only sub-regions above and/or below an overall surface.

In this case it is again possible in particular for layers lying one above the other to be joined together, whereby they can either be continuously joined together at least essentially or be only partially joined together.

The reinforcing matrix or the reinforcing threads or strips can be applied at least partially onto a carrier.

It is expedient for the reinforcing matrix and/or the carrier to be formed from different materials at least in some regions.

In certain cases it is also advantageous for the reinforcing threads or strips to be formed at least partly from different materials.

The paper machine clothing or its reinforcing matrix is advantageously constructed such that a different permeability results from region to region.

The pores formed by the reinforcing matrix each have a size preferably in a range from around 0.015 to around 10 mm².

The reinforcing elements can be thread shaped, such as monofile or multifile for example, or strip shaped, like PP strips for example.

On an advantageous alternative embodiment of the paper machine clothing according to the invention, the reinforcing elements are produced through application by pressing, melting, knife-coating, extrusion and/or the like.

According to another expedient alternative embodiment, the reinforcing elements can also be produced by way of a reductive treatment such as, in particular, chemical etching, laser etching and/or the like.

It is advantageous for different layers of the reinforcing matrix or for reinforcing threads or strips lying one above the other to be directly joined together at least in some regions. In principle, however, an indirect bond by way of a film or the like is also possible.

As already mentioned, the paper machine clothing of the invention can also be constructed as a press belt, preferably as a press felt.

Furthermore, it is possible for the paper machine clothing of the invention to be used in the transfer or smoothing area of a paper machine as a so-called process belt or transfer belt. Also, the inventive paper machine clothing of the invention can be used in a central roller press as a so-called center belt which enwraps the central roller.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of various examples of polygonal pore structures such as result from thread plaitings of differently oriented threads;

FIG. 2 is a schematic representation of a section of a paper machine clothing with a multilayer reinforcing matrix, which has pores superimposed on each other;

FIG. 3 is a schematic plan view of a section of a reinforcing matrix with different reinforcing regions viewed in the transverse direction;

FIG. 4 is a schematic side view of a reinforcing matrix with a layer of reinforcing threads oriented in the machine running direction, on which more layers are arranged in the middle region and in the edge regions;

FIG. 5 is a schematic plan view of a section of a reinforcing matrix with an asymmetric distribution of reinforcing threads of different orientation with respect to the machine running direction; and

FIG. 6 is a schematic plan view of a section of a reinforcing matrix with different reinforcing regions viewed in the transverse direction, whereby the different reinforcing regions are symmetrically distributed as viewed in the transverse direction.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

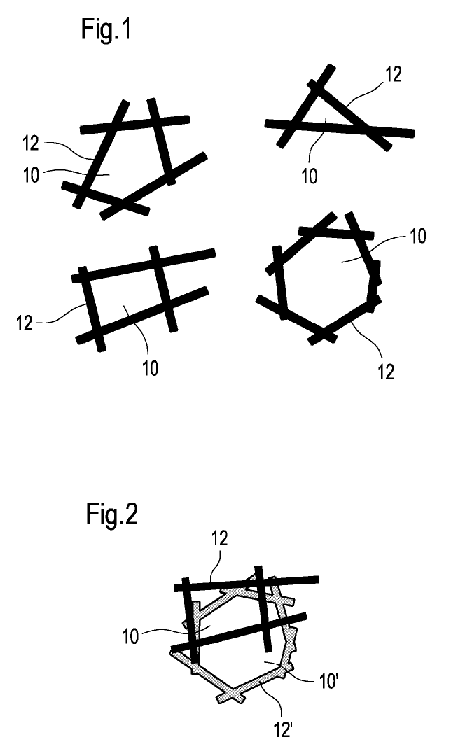

Referring now to the drawings, and more particularly to FIG. 1, there is shown, in a schematic representation, different examples of polygonal pore structures. In this case the different pores 10 are each limited by linear reinforcing elements of different orientation, which in the case in question are each formed by at least three intersecting reinforcing threads 12 of different orientation.

In this case these polygonal pore structures can be represented by thread plaitings with differently oriented threads for example.

FIG. 2 shows, in a schematic representation, a section of a paper machine clothing with a multilayer reinforcing matrix, which has pores 10, 10′ superimposed on each other.

In the current case, too, the pores 10, 10′ are each limited again by several linear reinforcing elements or reinforcing threads 12 or 12′ of different orientation.

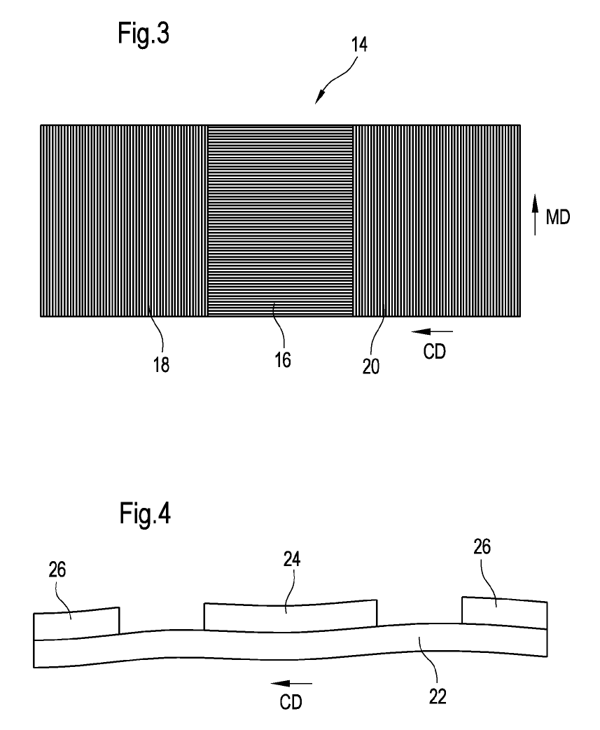

FIG. 3 shows, in a schematic plan view, a section of a reinforcing matrix 14 with different reinforcing regions 16, 18, 20 as viewed in the transverse direction CD.

In this case provision is made in a middle reinforcing region 16 for a thread plaiting with multiaxially oriented threads, which includes three layers for example, whereby the threads of the three layers are oriented in at least three different directions.

The left reinforcing region 18 in FIG. 3 is formed like the reinforcing region 20 adjacent to the right of the middle reinforcing region 16 by a single-layer thread plaiting with threads oriented in just one direction, for example in the machine running direction MD.

FIG. 4 shows, in a schematic side view, a reinforcing matrix 14 with a layer 22 of reinforcing threads oriented in the machine running direction, onto which is applied in the middle region at least one more layer with reinforcing threads oriented in the transverse direction CD and in each of the two edge regions at least one more layer 26 with reinforcing threads of multiaxial orientation. In this case, each of the multiaxial layers 26 in the two edge regions again contain preferably a plurality of reinforcing threads oriented in at least three different directions.

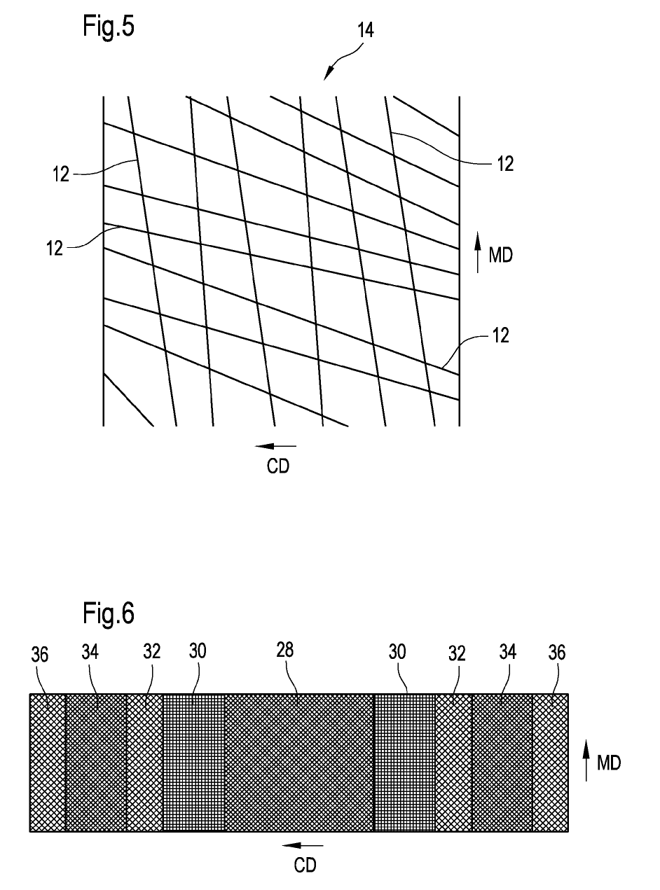

FIG. 5 shows, in a schematic plan view, a section of a reinforcing matrix 14 with an asymmetric distribution of reinforcing threads 12 of different orientation with respect to the machine running direction L.

The tendency toward marking is again reduced accordingly by the corresponding distribution of differently oriented reinforcing threads 12 of the reinforcing matrix 14 serving as felt carrier for example.

The constellation evident from this FIG. 5 can also be arranged in several layers one above the other.

FIG. 6 shows, in a schematic plan view, a section of a reinforcing matrix 14 with different reinforcing regions 28 to 36 as viewed in the transverse direction CD, which, as is evident from FIG. 6, are symmetrically distributed in the case in question as viewed in the transverse direction. The various reinforcing regions 28 to 36 can again differ from each other in particular in respect of their fiber orientation.

It is possible, also in the case under consideration, for the paper machine clothing in question to be used preferably as a press felt or as a transfer, process or center belt such that the reinforcing layers distributed symmetrically across the overall width serve as a reinforcing structure for this belt or felt.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### List of Reference Numerals

10 Pore
10′ Pore
12 Reinforcing element, reinforcing thread
12′ Reinforcing element, reinforcing thread
14 Reinforcing matrix
16 Reinforcing region
18 Reinforcing region
20 Reinforcing region
22 Layer with reinforcing threads oriented in the machine running direction
24 Layer with reinforcing threads oriented in the transverse direction
26 Layer with multiaxially orientated reinforcing threads
28 Reinforcing region
30 Reinforcing region
32 Reinforcing region
34 Reinforcing region
CD Transverse direction
MD Machine running direction

What is claimed is:

1. A paper machine clothing, comprising:
a reinforcing matrix including at least one of: a plurality of linear reinforcing elements oriented in at least three different directions, and a plurality of non-linear reinforcing elements.

2. The paper machine clothing according to claim 1, wherein said plurality of linear reinforcing elements are oriented in at least three different directions as viewed in one of a plane and a surface of the paper machine clothing extending in a machine running direction and in a transverse direction.

3. The paper machine clothing according to claim 1, wherein said plurality of linear reinforcing elements are oriented in more than three different directions.

4. The paper machine clothing according to claim 1, wherein said plurality of linear reinforcing elements includes a plurality of reinforcing one of threads and strips, said reinforcing matrix including at least one thread plaiting with said plurality of reinforcing one of threads and strips.

5. The paper machine clothing according to claim 1, wherein at least a part of said plurality of linear reinforcing elements is oriented in at least one of a machine running direction, a transverse direction, and a direction extending obliquely with respect to said machine running direction.

6. The paper machine clothing according to claim 1, wherein one of said plurality of linear reinforcing elements are oriented only partially in at least three different directions as viewed in a transverse direction and the paper machine clothing includes non-linear reinforcing elements.

7. The paper machine clothing according to claim 1, wherein said plurality of reinforcing elements form a plurality of pores at least in some regions of the paper machine clothing.

8. The paper machine clothing according to claim 1, wherein said plurality of reinforcing elements form a plurality of polygonal pore structures at least in some regions of the paper machine clothing.

9. The paper machine clothing according to claim 1, wherein said reinforcing matrix is a multilayer reinforcing matrix.

10. The paper machine clothing according to claim 9, wherein said plurality of linear reinforcing elements form a plurality of pores which are superimposed on each other.

11. The paper machine clothing according to claim 1, wherein said reinforcing matrix, viewed in a transverse direction, includes a plurality of different reinforcing regions which differ from each other as to at least one of an orientation and a distribution of said plurality of linear reinforcing elements.

12. The paper machine clothing according to claim 11, wherein said plurality of different reinforcing regions, as viewed in said transverse direction, are distributed symmetrically relative to a middle of the paper machine clothing.

13. The paper machine clothing according to claim 11, wherein said plurality of different reinforcing regions, as viewed in said transverse direction, are distributed asymmetrically relative to a middle of the paper machine clothing.

14. The paper machine clothing according to claim 1, wherein said plurality of linear reinforcing elements, viewed in a transverse direction, have an asymmetric distribution of orientation relative to a middle of the paper machine clothing.

15. The paper machine clothing according to claim 14, wherein said plurality of linear reinforcing elements are distributed over a plurality of layers.

16. The paper machine clothing according to claim 1, wherein said plurality of linear reinforcing elements includes a plurality of reinforcing one of threads and strips, said reinforcing matrix including a plurality of layers with said plurality of reinforcing one of threads and strips of different orientation extending across one of an overall width and an overall surface of the paper machine clothing.

17. The paper machine clothing according to claim 16, wherein said plurality of layers are joined together.

18. The paper machine clothing according to claim 17, wherein said plurality of layers are at least essentially continuously joined together.

19. The paper machine clothing according to claim 17, wherein said plurality of layers are partially joined together.

20. The paper machine clothing according to claim 1, wherein said plurality of linear reinforcing elements includes a plurality of reinforcing one of threads and strips, said reinforcing matrix including a plurality of layers with said plurality of reinforcing one of threads and strips of different orientation extending across only at least one sub-region of one of a width and a surface of the paper machine clothing.

21. The paper machine clothing according to claim 20, wherein said plurality of layers are joined together.

22. The paper machine clothing according to claim 21, wherein said plurality of layers are at least essentially continuously joined together.

23. The paper machine clothing according to claim 21, wherein said plurality of layers are partially joined together.

24. The paper machine clothing according to claim 1, wherein said plurality of linear reinforcing elements includes a plurality of reinforcing one of threads and strips, said reinforcing matrix including a plurality of layers with said plurality of reinforcing one of threads and strips of different orientation extending across only a plurality of sub-regions at least one of above and below an overall surface.

25. The paper machine clothing according to claim 24, wherein said plurality of layers are joined together.

26. The paper machine clothing according to claim 25, wherein said plurality of layers are at least essentially continuously joined together.

27. The paper machine clothing according to claim 25, wherein said plurality of layers are partially joined together.

28. The paper machine clothing according to claim 1, further including a carrier, said plurality of linear reinforcing elements including a plurality of reinforcing one of threads and strips, one of said reinforcing matrix and said plurality of reinforcing one of threads and strips being applied at least partially onto said carrier.

29. The paper machine clothing according to claim 28, wherein at least one of said reinforcing matrix and said carrier is formed from a plurality of different materials in a plurality of regions of the paper machine clothing.

30. The paper machine clothing according to claim 1, wherein said plurality of linear reinforcing elements includes a plurality of reinforcing one of threads and strips which are formed from a plurality of different materials in a plurality of regions of the paper machine clothing.

31. The paper machine clothing according to claim 1, wherein the paper machine clothing has a different permeability from region to region of the paper machine clothing.

32. The paper machine clothing according to claim 1, wherein said reinforcing matrix forms a plurality of pores each of which has a size which lies in a range from around 0.015 to around 10 mm².

33. The paper machine clothing according to claim 1, wherein said plurality of linear reinforcing elements includes a thread material.

34. The paper machine clothing according to claim 1, wherein said plurality of linear reinforcing elements are produced by at least one of pressing, melting, knife-coating, and extruding.

35. The paper machine clothing according to claim 1, wherein said plurality of linear reinforcing elements are produced by a reductive treatment.

36. The paper machine clothing according to claim 35, wherein said plurality of linear reinforcing elements are produced by at least one of chemical etching and laser etching.

37. The paper machine clothing according to 1, wherein said plurality of linear reinforcing elements includes a plurality of reinforcing one of threads and strips, the paper machine clothing including a plurality of different layers of one of said reinforcing matrix and said plurality of reinforcing one of threads and strips lying one above the other which are directly joined together at least in some regions of the paper machine clothing.

38. The paper machine clothing according to claim 1, wherein said plurality of linear reinforcing elements includes a plurality of reinforcing one of threads and strips, the paper machine clothing including a plurality of different layers of one of said reinforcing matrix and said plurality of reinforcing one of threads and strips lying one above the other which are indirectly joined together at least in some regions of the paper machine clothing using a film.

39. The paper machine clothing according to claim 1, wherein the paper machine clothing is a press belt.

40. The paper machine clothing according to claim 1, wherein the paper machine clothing is a press felt.
